(19) United States
(12) Patent Application Publication
(10) Pub. No.: US 2025/0046045 A1
(43) Pub. Date: Feb. 6, 2025

(54) METHOD AND APPARATUS FOR IMPLEMENTING MULTIMEDIA INTERACTION, DEVICE, AND STORAGE MEDIUM

(71) Applicant: TENCENT TECHNOLOGY (SHENZHEN) COMPANY LIMITED, Shenzhen (CN)

(72) Inventors: Mingjun TENG, Shenzhen (CN); Xiaoyu YU, Shenzhen (CN); Zhuocen JIANG, Shenzhen (CN); Yingyuan CAI, Shenzhen (CN); Zhao LI, Shenzhen (CN); Feng LI, Shenzhen (CN); Yizhou DU, Shenzhen (CN); Zixiang ZHAO, Shenzhen (CN); Zekai CHEN, Shenzhen (CN); Jianhui PAN, Shenzhen (CN); Geng TIAN, Shenzhen (CN)

(21) Appl. No.: 18/923,822

(22) Filed: Oct. 23, 2024

Related U.S. Application Data
(63) Continuation of application No. PCT/CN2023/131382, filed on Nov. 14, 2023.

(30) Foreign Application Priority Data
Dec. 28, 2022 (CN) 202211702098.6

(51) Int. Cl. G06T 19/20

(52) U.S. Cl. CPC G06T 19/20; G06T 2219/024; G06T 2219/2004; G06T 2219/2024

(57) ABSTRACT

A method for implementing multimedia interaction includes displaying a first user interface that includes a virtual building representing an entrance to a multimedia interaction room and a virtual object that are located in a virtual scene, in response to a movement control operation on the virtual object, displaying that the virtual object moves from a first position to a second position in the virtual scene, and, in response to that the virtual object satisfies an entry condition of the virtual building, displaying a second user interface that includes the virtual building, the virtual object, and an interaction control. The entry condition at least includes the second position being within an effective response range of the virtual building.

### CROSS-REFERENCE TO RELATED APPLICATIONS

This application is a continuation of International Application No. PCT/CN2023/131382, filed on Nov. 14, 2023, which claims priority to Chinese Patent Application No. 202211702098.6, filed with the China National Intellectual Property Administration on Dec. 28, 2022, the entire contents of both of which are incorporated herein by reference.

### FIELD OF THE TECHNOLOGY

This application relates to the field of computer technologies, and in particular, to a method and an apparatus for implementing multimedia interaction, a device, and a storage medium.

### BACKGROUND OF THE DISCLOSURE

In recent years, in the field of stranger socializing, a quantity of users performing voice chatting online continuously increases.

For example, a user may enter a dedicated message interface for a voice room, and select a to-be-joined voice room based on a name or a room number of the voice room. After joining the voice room, the user starts performing microphone-connected interaction with another user in the voice room.

### SUMMARY

In accordance with the disclosure, there is provided a method for implementing multimedia interaction including displaying a first user interface that includes a virtual building representing an entrance to a multimedia interaction room and a virtual object that are located in a virtual scene, in response to a movement control operation on the virtual object, displaying that the virtual object moves from a first position to a second position in the virtual scene, and, in response to that the virtual object satisfies an entry condition of the virtual building, displaying a second user interface that includes the virtual building, the virtual object, and an interaction control. The entry condition at least includes the second position being within an effective response range of the virtual building.

Also in accordance with the disclosure, there is provided a computer device including at least one processor, and at least one memory storing at least one program that, when executed by the at least one processor, causes the computer device to display a first user interface that includes a virtual building representing an entrance to a multimedia interaction room and a virtual object that are located in a virtual scene, in response to a movement control operation on the virtual object, display that the virtual object moves from a first position to a second position in the virtual scene, and, in response to that the virtual object satisfies an entry condition of the virtual building, display a second user interface that includes the virtual building, the virtual object, and an interaction control. The entry condition at least includes the second position being within an effective response range of the virtual building.

Also in accordance with the disclosure, there is provided a non-transitory computer-readable storage medium storing one or more executable instructions that, when loaded and executed by at least one processor of a computer device, cause the computer device to display a first user interface that includes a virtual building representing an entrance to a multimedia interaction room and a virtual object that are located in a virtual scene, in response to a movement control operation on the virtual object, display that the virtual object moves from a first position to a second position in the virtual scene, and, in response to that the virtual object satisfies an entry condition of the virtual building, display a second user interface that includes the virtual building, the virtual object, and an interaction control. The entry condition at least includes the second position being within an effective response range of the virtual building.

### BRIEF DESCRIPTION OF THE DRAWINGS

FIG. 1 is a schematic diagram of a computer system according to some embodiments of this application.

FIG. 2 is a schematic diagram showing a virtual scene according to some embodiments of this application.

FIG. 3 is a flowchart of a method for implementing multimedia interaction according to some embodiments of this application.

FIG. 4 is a flowchart of a method for implementing multimedia interaction according to some embodiments of this application.

FIG. 5 is a flowchart of a method for implementing multimedia interaction according to some embodiments of this application.

FIG. 6 is a flowchart of a method for implementing multimedia interaction according to some embodiments of this application.

FIG. 7 is a flowchart of a method for implementing multimedia interaction according to some embodiments of this application.

FIG. 8 is a flowchart of a method for implementing multimedia interaction according to some embodiments of this application.

FIG. 9 is a flowchart of a method for implementing multimedia interaction according to some embodiments of this application.

FIG. 10 is a flowchart of a method for implementing multimedia interaction according to some embodiments of this application.

FIG. 11 is a flowchart of a method for implementing multimedia interaction according to some embodiments of this application.

FIG. 12 is a flowchart of a method for implementing multimedia interaction according to some embodiments of this application.

FIG. 13 is a schematic diagram showing an identity information interface according to some embodiments of this application.

FIG. 14 is a flowchart of a method for implementing multimedia interaction according to some embodiments of this application.

FIG. 15 is a flowchart of a method for implementing multimedia interaction according to some embodiments of this application.

FIG. 16 is a schematic diagram showing a virtual scene according to some embodiments of this application.

FIG. 17 is a block diagram showing a structure of an apparatus for implementing multimedia interaction according to some embodiments of this application.

FIG. 18 is a block diagram showing a structure of a computer device according to some embodiments of this application.

### DESCRIPTION OF EMBODIMENTS

To make objectives, technical solutions, and advantages of this application clearer, implementations of this application are further described below in detail with reference to the accompanying drawings.

Exemplary embodiments are described in detail herein, and examples of the exemplary embodiments are shown in the accompanying drawings. When the following descriptions are made with reference to the accompanying drawings, unless otherwise indicated, same numbers in different accompanying drawings represent same or similar elements. Implementations described in the following exemplary embodiments do not represent all implementations that are consistent with this application. Instead, the implementations are merely examples of an apparatus and a method that are described in detail in the appended claims and that are consistent with some aspects of this application.

Terms used in this disclosure are merely used to describe specific embodiments but are not intended to limit this disclosure. The singular forms of “a” and “the” used in this disclosure and the appended claims are also intended to include the plural forms, unless otherwise specified in the context clearly. The term “and/or” used in this specification indicates and includes any or all possible combinations of one or more associated listed items.

The user information (including, but not limited to, user equipment information, user personal information, and the like), data (including, but not limited to, data for analysis, stored data, displayed data, and the like), involved in this application all are information and data that are authorized by the user or fully authorized by all parties, and the collection, use, and processing of relevant data need to comply with relevant laws and regulations of relevant countries and regions. For example, information such as a movement control operation or an interaction label involved in this application is obtained with full authorization.

Although the terms such as “first,” “second,” and “third” may be used in this disclosure to describe various information, the information is not limited to these terms. These terms are merely used to distinguish between information of the same type. For example, without departing from a scope of the disclosure, a first parameter may also be referred to as a second parameter, and similarly, the second parameter may also be referred to as the first parameter. Depending on the context, for example, the word “if” used herein may be interpreted as “while,” “when,” or “in response to determining.”

In this disclosure, the phrases “at least one of A, B, and C” and “at least one of A, B, or C” both mean only A, only B, only C, or any combination of A, B, and C.

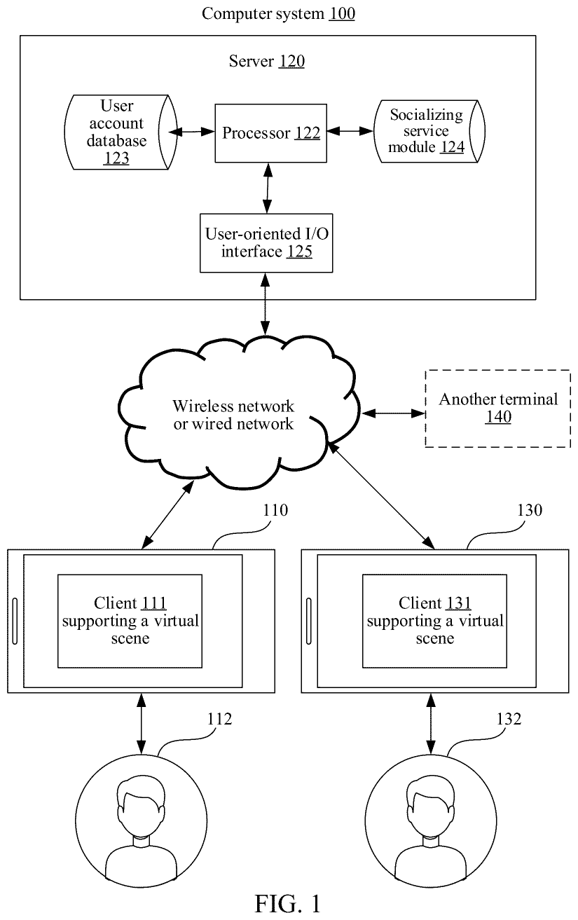

FIG. 1 is a block diagram showing a structure of a computer system 100 according to some embodiments of this application. The computer system 100 includes: a first terminal 110, a server 120, and a second terminal 130.

A client 111 supporting a virtual scene is installed and run on the first terminal 110, and the client 111 may be a multiuser online socializing program. When the first terminal 110 runs the client 111, a user interface of the client 111 is displayed on a screen of the first terminal 110. The client 111 may be an instant messaging (IM) program, for example, an application program for performing a social activity based on a virtual map. The client 111 may alternatively be implemented as another application program having a function of multiuser online socializing, such as any one of a payment application having the function of multiuser online socializing, a virtual reality (VR) application program, an augmented reality (AR) program, a three-dimensional map program, and a game application. The game application specifically includes any one of a battle royale shooting game, a virtual reality game, an augmented reality game, a first-person shooting (FPS) game, a third-person shooting (TPS) game, a multiplayer online battle arena (MOBA) game, and a simulation game (SLG). In this embodiment, an example in which the client 111 is the instant messaging program is used for description. The first terminal 110 is a terminal used by a first user 112. The first user 112 uses the first terminal 110 to control a first virtual object located in a virtual scene to perform an activity, to implement multiuser online socializing. The first virtual object may be referred to as a virtual object of the first user 112. The activity of the first virtual object includes, but is not limited to: at least one of moving, transferring, releasing a skill, using an item, adjusting a body posture, crawling, walking, running, riding, flying, jumping, driving, picking, shooting, attacking, or throwing. For example, the first virtual object is a first virtual character, such as a simulated human character or an animated human character.

A client 131 supporting the virtual scene is installed and run on the second terminal 130, and the client 131 may be a multiuser online socializing program. When the second terminal 130 runs the client 131, a user interface of the client 131 is displayed on a screen of the second terminal 130. Similar to the client 111 installed on the first terminal 110, the client 131 may be any one of the instant messaging program, the payment application having the function of multiuser online socializing, the VR application program, the AR program, the three-dimensional map program, and the game application. In this embodiment, an example in which the client 131 is the instant messaging program is used for description. The second terminal 130 is a terminal used by a second user 132. The second user 132 uses the second terminal 130 to control a second virtual object located in the virtual scene to perform an activity. The second virtual object may be referred to as a virtual object of the second user 132. For example, the second virtual object is a second virtual character such as the simulated human character or the animated human character.

In some embodiments, the first virtual object and the second virtual object are located in a same virtual scene. In some embodiments, the first virtual object and the second virtual object may belong to a same camp, a same team, or a same organization, have a friend relationship with each other, or have temporary communication permission. In some embodiments, the first virtual object and the second virtual object may belong to different camps, different teams, or different organizations, or have a hostile relationship with each other.

In some embodiments, the clients installed on the first terminal 110 and the second terminal 130 are the same, or the clients installed on the two terminals are a same type of clients on different operating system platforms (Android or iOS). The first terminal 110 may generally refer to one of a plurality of terminals, and the second terminal 130 may generally refer to another one of the plurality of terminals. In this embodiment, the first terminal 110 and the second terminal 130 are merely used as an example for description. Device types of the first terminal 110 and the second terminal 130 are the same or different. The device type includes: at least one of a smartphone, a head-mounted device, a wearable device, a tablet computer, an e-book reader, a moving picture experts group audio layer III (MP3) player, a moving picture experts group audio layer IV (MP4) player, a laptop portable computer, and a desktop computer.

FIG. 1 shows only two terminals. However, a plurality of other terminals 140 may access the server 120 in different embodiments. In some embodiments, one or more terminals 140 are terminals corresponding to a developer. A developing and editing platform for the client supporting a virtual scene is installed on the terminal 140. The developer may edit and update the client on the terminal 140 and transmit an installation package of an updated client to the server 120 through a wired or wireless network. The first terminal 110 and the second terminal 130 may download the installation package of the client from the server 120 to update the client.

The first terminal 110, the second terminal 130, and the other terminals 140 are connected to the server 120 through the wired or wireless network.

The server 120 may include at least one of one server, a plurality of servers, a cloud computing platform, and a virtualization center. The server 120 is configured to provide a background service for a client supporting a three-dimensional virtual scene. In some embodiments, the server 120 is responsible for primary computing, and the terminal is responsible for secondary computing. Alternatively, the server 120 is responsible for secondary computing, and the terminal is responsible for primary computing. Alternatively, collaborative computing is performed by using a distributed computing architecture between the server 120 and the terminal.

In a schematic example, the server 120 includes a processor 122, a user account database 123, a socializing service module 124, and a user-oriented input/output interface (I/O interface) 125. The processor 122 is configured to load instructions stored in the server 120, and process data in the user account database 123 and the socializing service module 124. The user account database 123 is configured to store data of user accounts used in the first terminal 110, the second terminal 130, and the other terminals 140, for example, an avatar of the user account, a nickname of the user account, historical behavioral data of the user account, and a service region in which the user account is located. The socializing service module 124 is configured to provide interaction between a plurality of users, such as at least one of transmitting a voice message, performing an interaction action, and delivering a virtual gift. The user-oriented I/O interface 125 is configured to establish communication with the first terminal 110 and/or the second terminal 130 through the wired or wireless network to exchange data.

The method provided in the embodiments of this application may be applied to, but is not limited to, at least one of the following scenarios: a virtual reality application program, a three-dimensional map program, a first-person shooting game, a third-person shooting game, a multiplayer online battle arena game, a multiplayer gunfight survival game, and the like. The following embodiments are described by using an example in which the method is applied to a game.

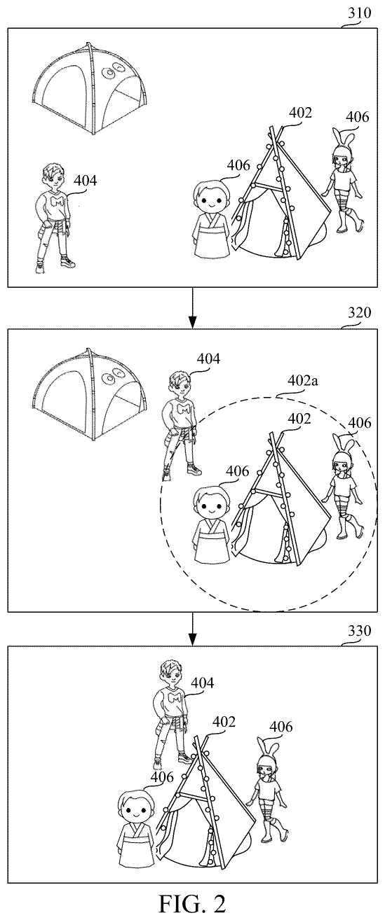

FIG. 2 is a schematic diagram showing a virtual scene according to some embodiments of this application.

A virtual building 402 is displayed on a first interface 310. The virtual building 402 corresponds to a multimedia interaction room. In the embodiment shown in FIG. 2, the virtual building 402 is specifically displayed as a virtual tent. A first virtual object 404 and a second virtual object 406 are displayed on the first interface 310. The second virtual object 406 is a virtual object that has joined the multimedia interaction room, and the first virtual object 404 does not join the multimedia interaction room on the first interface 310.

In response to that a position of the first virtual object 404 changes, a second interface 320 is displayed. On the second interface 320, the first virtual object 404 is located within a range of an effective response region 402a of the virtual building 402. The effective response region 402a is a region centered on the virtual building 402, and a distance between the effective response region 402a and the virtual building 402 is less than a distance threshold.

In response to a trigger operation on the virtual building 402, a third interface 330 is displayed. The first virtual object 404 approaches the second virtual object 406, the first virtual object 404 joins an interaction queue formed by the second virtual objects 406 and is displayed around the virtual building 402, and a first user corresponding to the first virtual object 404 joins the multimedia interaction room.

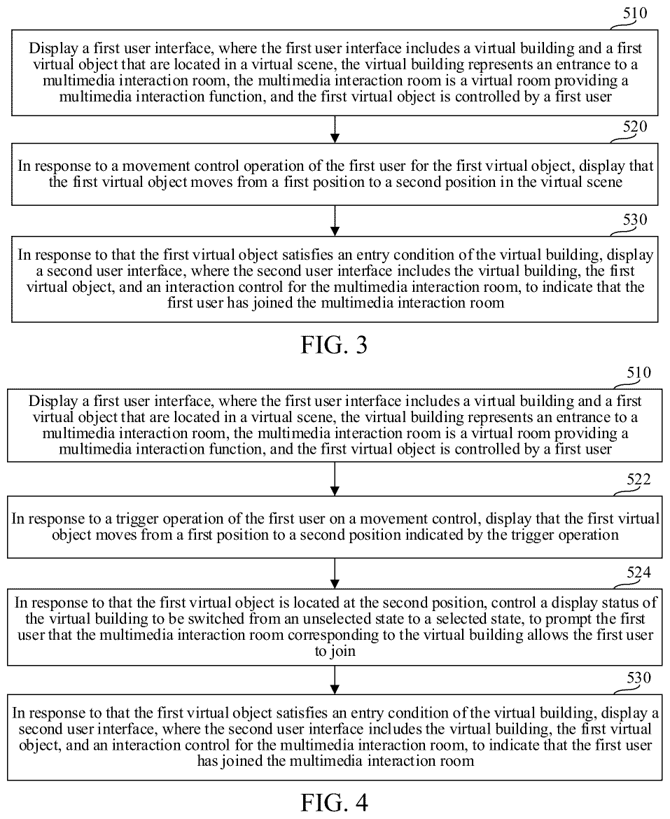

FIG. 3 is a flowchart of a method for implementing multimedia interaction according to some embodiments of this application. An example in which the method is performed by a terminal is used for description. The method includes the following operations.

Operation 510: Display a first user interface, where the first user interface includes a virtual building and a first virtual object that are located in a virtual scene, the virtual building represents an entrance to a multimedia interaction room, the multimedia interaction room is a virtual room providing a multimedia interaction function, and the first virtual object is controlled by a first user.

For example, the virtual building is a building that represents the multimedia interaction room in the virtual scene, the multimedia interaction room is configured for providing the multimedia interaction function for at least two users, and the first virtual object is a virtual character controlled by the first user. For example, the virtual scene may carry one or more virtual buildings and one or more virtual objects. For example, users corresponding to a plurality of virtual objects in the virtual scene usually belong to a same platform, but a situation in which the users belong to different platforms is not excluded. For example, the platform includes, but is not limited to, at least one of a social platform, a payment platform, a game platform, and an audio and video platform.

Operation 520: In response to a movement control operation of the first user for the first virtual object, display that the first virtual object moves from a first position to a second position in the virtual scene.

For example, the movement control operation for the first virtual object is configured for changing a position of the first virtual object in the virtual scene. An implementation of the movement control operation for the first virtual object includes, but is not limited to, at least one of the following: tapping, sliding, and rotating, for example, tapping a touchscreen or a key, sliding the touchscreen or a gamepad, and rotating a terminal or a gamepad.

Operation 530: In response to that the first virtual object satisfies an entry condition of the virtual building, display a second user interface, where the second user interface includes the virtual building, the first virtual object, and an interaction control for the multimedia interaction room, to indicate that the first user has joined the multimedia interaction room.

For example, the entry condition at least includes the second position being within an effective response range of the virtual building. For example, a distance between the second position and the virtual building is less than a distance threshold. For example, when the first user joins the multimedia interaction room, the first virtual object may be displayed around the virtual building, or the first virtual object may be displayed entering the virtual building. This is not limited.

In conclusion, in the method provided in this embodiment, the multimedia interaction room is displayed as the virtual building in the virtual scene, and the user corresponding to the first virtual object joins the multimedia interaction room when the entry condition of the virtual building is satisfied, so that a manner of joining the multimedia interaction room is expanded in the virtual scene. Joining the multimedia interaction room is transformed into an activity behavior of the virtual object in the virtual scene, so that interaction of the virtual object in the virtual scene is promoted, immersive experience in the virtual scene is improved, and a complicated interaction process of opening a message interface and joining the multimedia interaction room on the message interface is avoided, thereby improving human-computer interaction efficiency.

FIG. 4 is a flowchart of a method for implementing multimedia interaction according to some embodiments of this application. An example in which the method is performed by a terminal is used for description. To be specific, in the embodiment shown in FIG. 3, operation 520 may be implemented as operation 522 and operation 524.

Operation 522: In response to a trigger operation of the first user on a movement control, display that the first virtual object moves from the first position to the second position indicated by the trigger operation.

For example, the movement control operation for the first virtual object is specifically implemented as the trigger operation on the movement control. In response to the trigger operation on the movement control, the position of the first virtual object is changed. The movement control may directly indicate the second position, or may indirectly indicate the second position by indicating a movement direction of the first virtual object.

Operation 524: In response to that the first virtual object is located at the second position, control a display status of the virtual building to be switched from an unselected state to a selected state, to prompt the first user that the multimedia interaction room corresponding to the virtual building allows the first user to join.

In some embodiments, the method further includes: receiving a tap operation of the first user on the virtual building in the selected state; and in response to the tap operation, determining that the first virtual object satisfies the entry condition of the virtual building.

For example, when the first virtual object is located at the second position, a distance between the position of the first virtual object and the virtual building is less than the distance threshold, the virtual building is in an operable state, and the first user may join the multimedia interaction room when the entry condition of the virtual building is satisfied. The display status of the virtual building is switched from the unselected state to the selected state, to prompt the first user that the multimedia interaction room corresponding to the virtual building allows the first user to join. The selected state is a response of the virtual building to the first virtual object being located at the second position.

In conclusion, in the method provided in this embodiment, the position of the first virtual object is changed through the trigger operation on the movement control, the multimedia interaction room is displayed as the virtual building in the virtual scene, and the virtual building is displayed to be in the selected state when the first virtual object is located at the second position, so that a manner of joining the multimedia interaction room is expanded in the virtual scene. Joining the multimedia interaction room is transformed into an activity behavior of the virtual object in the virtual scene, so that interaction of the virtual object in the virtual scene is promoted, immersive experience in the virtual scene is improved, and a complicated interaction process of opening a message interface and joining the multimedia interaction room on the message interface is avoided, thereby improving human-computer interaction efficiency.

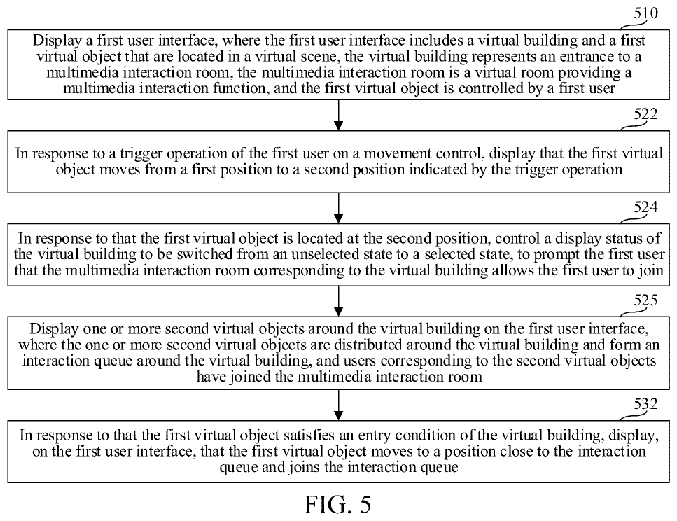

FIG. 5 is a flowchart of a method for implementing multimedia interaction according to some embodiments of this application. An example in which the method is performed by a terminal is used for description. To be specific, based on the embodiment shown in FIG. 4, operation 525 is further included, and operation 530 may be implemented as operation 532.

Operation 525: Display one or more second virtual objects around the virtual building on the first user interface, where the one or more second virtual objects are distributed around the virtual building and form an interaction queue around the virtual building, and users corresponding to the second virtual objects have joined the multimedia interaction room.

For example, the second virtual object is a virtual object that has joined the multimedia interaction room. A quantity of second virtual objects may be one or more. Further, a distance between the second virtual object and the virtual building is less than the distance threshold. When there are a plurality of second virtual objects, the second virtual objects may be arranged evenly around the virtual building, or may be arranged randomly around the virtual building. This is not limited in this embodiment.

Operation 532: In response to that the first virtual object satisfies the entry condition of the virtual building, display, on the first user interface, that the first virtual object moves to a position close to the interaction queue and joins the interaction queue.

For example, the interaction queue is displayed around the virtual building. That the first virtual object joins the interaction queue formed by the second virtual objects is configured for indicating that the first user corresponding to the first virtual object joins the multimedia interaction room. In this embodiment, when the first user joins the multimedia interaction room, the first virtual object does not enter the virtual building, and the first virtual object is displayed around the virtual building.

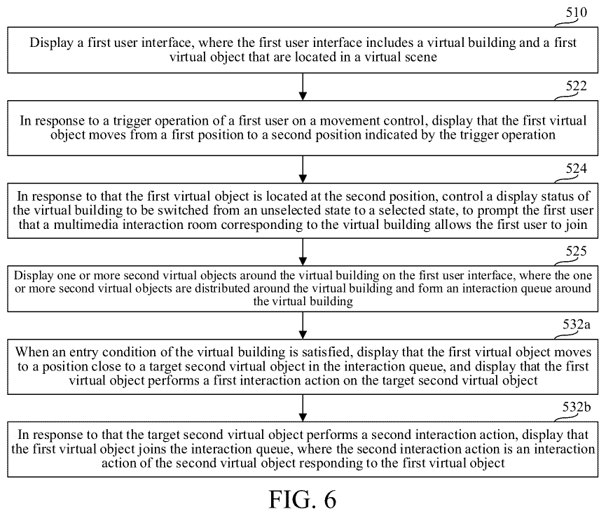

In some embodiments, as shown in FIG. 6, in an implementation of this application, the one or more second virtual objects include a target second virtual object, and the target second virtual object has management permission of the multimedia interaction room. Operation 532 in this embodiment may be implemented as the following operations.

Operation 532a: When the entry condition of the virtual building is satisfied, display that the first virtual object moves to a position close to the target second virtual object in the interaction queue, and display that the first virtual object performs a first interaction action on the target second virtual object.

For example, the target second virtual object has the management permission of the multimedia interaction room. When the entry condition of the virtual building is satisfied, the first virtual object requests, by approaching the target second virtual object, the target second virtual object to agree that the first user joins the multimedia interaction room.

For example, the first interaction action includes, but is not limited to, at least one of reaching out an arm, raising a palm, and delivering a virtual item.

Operation 532b: In response to that the target second virtual object performs a second interaction action, display that the first virtual object joins the interaction queue, where the second interaction action is an interaction action of the second virtual object responding to the first virtual object.

For example, the target second virtual object performing the second interaction action is displayed, where the second interaction action is the interaction action of the second virtual object responding to the first virtual object. The target second virtual object performing the second interaction action is displayed, to indicate that the target second virtual object having the management permission of the multimedia interaction room allows the first user to join the multimedia interaction room.

For example, the second interaction action includes, but is not limited to, at least one of shaking hand with the first virtual object, clapping palm with first virtual object, and receiving the virtual item delivered by the first virtual object.

In conclusion, in the method provided in this embodiment, the multimedia interaction room is displayed as the virtual building in the virtual scene, and the first virtual object approaches the second virtual object to form an interaction queue, so that a manner of joining the multimedia interaction room is expanded in the virtual scene. Joining the multimedia interaction room is transformed into an activity behavior of the virtual object in the virtual scene, and an interaction behavior of a user corresponding to the first virtual object in the multimedia interaction room is displayed as the interaction queue in the virtual scene, so that interaction of the virtual object in the virtual scene is promoted, immersive experience in the virtual scene is improved, and a complicated interaction process of opening a message interface and joining the multimedia interaction room on the message interface is avoided, thereby improving human-computer interaction efficiency.

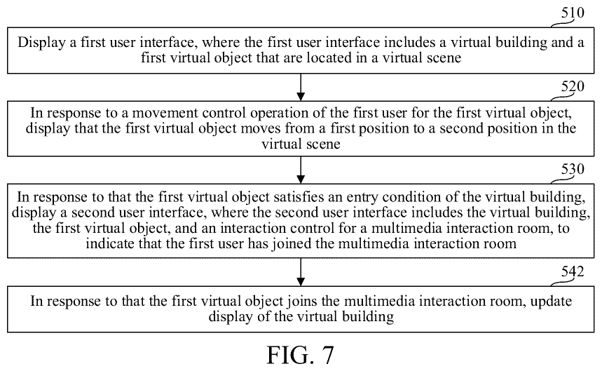

FIG. 7 is a flowchart of a method for implementing multimedia interaction according to some embodiments of this application. An example in which the method is performed by a terminal is used for description. To be specific, based on the embodiment shown in FIG. 3, operation 542 is further included.

Operation 542: In response to that the first virtual object joins the multimedia interaction room, update display of the virtual building.

For example, the first virtual object has capacity expansion permission of the multimedia interaction room. The capacity expansion permission possessed by the first virtual object may be obtained based on a first identity identifier possessed by the first virtual object. For example, the first identity identifier is a member identifier. Alternatively, the capacity expansion permission possessed by the first virtual object may be obtained in a virtual market. A manner of obtaining the capacity expansion permission by the first virtual object is not limited in this embodiment.

In some embodiments, if the first user has the capacity expansion permission of the multimedia interaction room, the virtual building is displayed in a second display style on the second user interface, to indicate that a maximum quantity of members allowed to be carried by the multimedia interaction room increases. The virtual building is displayed in a first display style on the first user interface, and the first display style is different from the second display style.

For example, a volume of the virtual building is positively correlated with the maximum quantity of members allowed to be carried by the multimedia interaction room. When the first virtual object has the capacity expansion permission of the multimedia interaction room, the volume of the virtual building is updated from a first volume to a second volume, and the first volume is smaller than the second volume.

In an implementation of this embodiment, at least one of image information, an identity identifier, and a decorative item of the first virtual object is further displayed on the virtual building. For example, in response to that the first virtual object expands the multimedia interaction room, the information related to the first virtual object is displayed on the virtual building.

Specifically, the image information of the first virtual object includes, but is not limited to, at least one of an avatar, a photo, and a virtual sculpture of the first virtual object. The identity identifier of the first virtual object includes, but is not limited to, at least one of a badge, a souvenir, and a member identifier of the first virtual object. The decorative item of the first virtual object displayed on the virtual building is provided by the first virtual object, and at least one of a color, a material, a pattern, and a texture of the decorative item is the same as that of virtual clothes worn by the first virtual object.

In an implementation of this embodiment, before the first user corresponding to the first virtual object joins the multimedia interaction room, the virtual building is further described.

For example, the volume of the virtual building in the virtual scene is positively correlated with the maximum quantity of members allowed to be carried by the multimedia interaction room. For example, before and after the first user joins the multimedia interaction room, if the maximum quantity of members allowed to be carried by the multimedia interaction room does not change, display of the virtual building is not updated.

In some embodiments, if the first user has an identity identifier and a quantity of users with the first identity identifier in the multimedia interaction room increases and exceeds a preset quantity threshold, the virtual building is displayed in a third display style on the second user interface, to indicate that the quantity of users with the first identity identifier in the multimedia interaction room exceeds the preset quantity threshold. The virtual building is displayed in a first display style on the first user interface, and the first display style is different from the third display style.

For example, the display style of the virtual building is related to the quantity of members with the first identity identifier in the multimedia interaction room. The first identifier may be a member identifier, or may be a type identifier of the first virtual object. For example, the display style of the virtual building includes, but is not limited to, at least one of a size, a color, a material, a pattern, and a texture. For example, the first identity identifier is a virtual craftsman type. When a quantity of people of the virtual craftsman type does not exceed a first quantity threshold, a size of a hammer identifier displayed on the virtual building is 200*200 pixels, and a material of the hammer is wood. When the quantity of people of the virtual craftsman type exceeds the first quantity threshold but does not exceed a second quantity threshold, the size of the hammer identifier is 300*300 pixels, the material of the hammer is metal, and a color of the hammer is silver. When the quantity of people of the virtual craftsman type exceeds the second quantity threshold, the size of the hammer identifier is 350*350 pixels, the material of the hammer is metal, the color of the hammer is gold, and a tassel pattern is displayed around the hammer.

In conclusion, in the method provided in this embodiment, display of the virtual building is updated after the first virtual object joins the multimedia interaction room. A virtual object in the virtual scene may continuously observe the virtual building, to learn of a change trend of the maximum quantity of members allowed to be carried by the multimedia interaction room, thereby avoiding frequent viewing on the multimedia interaction room and improving human-computer interaction efficiency.

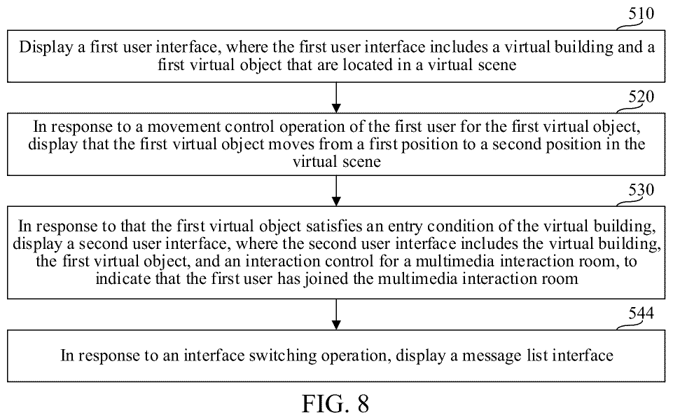

FIG. 8 is a flowchart of a method for implementing multimedia interaction according to some embodiments of this application. An example in which the method is performed by a terminal is used for description. To be specific, based on the embodiment shown in FIG. 3, operation 544 is further included.

Operation 544: In response to an interface switching operation, display a message list interface.

For example, in response to the interface switching operation, the terminal switches from displaying the virtual scene to displaying the message list interface. The message list interface is configured for displaying at least one multimedia interaction room, and the message list interface includes the multimedia interaction room joined by the first virtual object. For example, the message list interface is also referred to as an all in one (AIO) mode, and is configured for presenting a chat window for transmitting a message.

In an implementation of this embodiment, the message list interface further includes a multimedia interaction room of interest. The multimedia interaction room of interest is an interaction room corresponding to the virtual building whose display status is the selected state. For example, a joining control is displayed on the multimedia interaction room of interest in the message list interface, and the joining control is configured for providing a function entrance for the first user to join the multimedia interaction room of interest. Further, the virtual building whose display status is the selected state is switched from a zoomed size to an original size. A selected mark is displayed on the virtual building in the selected state. For example, one or more virtual buildings in the selected state may exist in the virtual scene simultaneously. For example, when the distance between the first virtual object and the virtual building is less than the distance threshold, the virtual building is displayed in the selected state, and there may be a plurality of virtual buildings whose distances to the first virtual object are less than the distance threshold.

In conclusion, in the method provided in this embodiment, the message list interface is displayed, so that the multimedia interaction room is displayed outside the virtual scene, and a connection is established between the virtual scene and the message list interface, thereby providing a function entrance for the first user to view a list message of the multimedia interaction room.

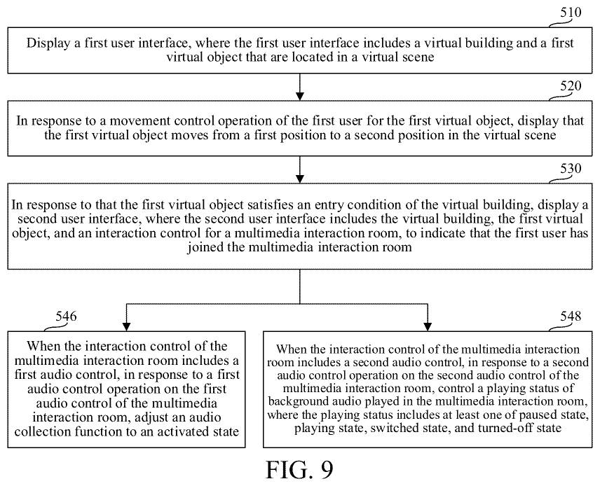

FIG. 9 is a flowchart of a method for implementing multimedia interaction according to some embodiments of this application. An example in which the method is performed by a terminal is used for description. To be specific, based on the embodiment shown in FIG. 3, operation 546 and operation 548 are further included.

Operation 546: When the interaction control of the multimedia interaction room includes a first audio control, in response to a first audio control operation on the first audio control of the multimedia interaction room, adjust an audio collection function to an activated state.

For example, the audio collection function is also referred to as a microphone function, and is configured for collecting voice by using a microphone of a terminal device. For example, the audio collection function may be configured for directly collecting original audio information, or may be configured for collecting audio information after time-frequency domain transformation is performed on the audio information, to obtain different audio effects, such as at least one of changing a sound volume, changing a tone, changing a timbre, and adding a time delay.

For example, the audio collection function may be configured for providing a real-time voice function for the first user, or may be configured for transmitting a voice message for a first account. This is not limited in this embodiment.

Operation 548: When the interaction control of the multimedia interaction room includes a second audio control, in response to a second audio control operation on the second audio control of the multimedia interaction room, control a playing status of background audio played in the multimedia interaction room, where the playing status includes at least one of paused state, playing state, switched state, and turned-off state.

For example, the background audio is played in the multimedia interaction room. The background audio may be audio uploaded by a user or music audio obtained through search.

For example, when the audio collection function of the multimedia interaction room is adjusted to the activated state, a sound volume of the background audio is adjusted from a first sound volume to a second sound volume, and the second sound volume is lower than the first sound volume. In this way, when the audio collection function is activated, the background audio does not affect the audio collection function.

In conclusion, in the method provided in this embodiment, the multimedia interaction room is displayed as the virtual building in the virtual scene, and the first user joins the multimedia interaction room when the entry condition of the virtual building is satisfied, so that a manner of joining the multimedia interaction room is expanded in the virtual scene. The multimedia interaction function provided by the multimedia interaction room is invoked through the first audio control operation and the second audio control operation, so that multimedia interaction between at least two users in the multimedia interaction room is implemented.

In some embodiments, the interaction control of the multimedia interaction room includes an exit control, and the method further includes:
in response to a tap operation of the first user on the exit control on the second user interface, transmitting a network request for exiting the virtual building to a service server;
receiving an exit success response returned by the service server, and disconnecting a persistent network connection with an audio and video server; and
in response to receiving the exit success response returned by the service server, returning to the first user interface from the second user interface, and displaying that the first virtual object returns to the first position.

The virtual building and the first virtual object are further described based on the embodiment shown in FIG. 9.

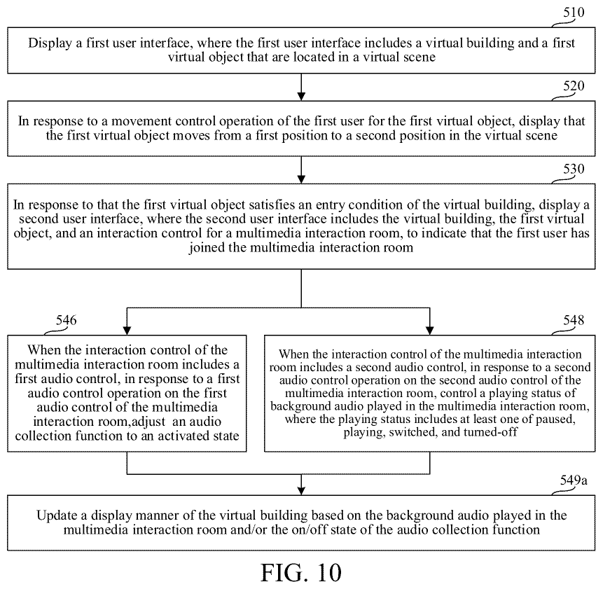

FIG. 10 is a flowchart of a method for implementing multimedia interaction according to some embodiments of this application. An example in which the method is performed by a terminal is used for description. To be specific, based on the embodiment shown in FIG. 9, operation 549a is further included.

Operation 549a: Update a display manner of the virtual building based on the background audio played in the multimedia interaction room and/or the on/off state of the audio collection function.

For example, the display manner of the virtual building is related to setting of the background audio and/or the on/off state of the audio collection function by the user in the multimedia interaction room. For example, for a third virtual object in the virtual scene, the third virtual object may observe the virtual building to learn of a situation of the setting of the background audio and/or the on/off state of the audio collection function by the user in the multimedia interaction room, and learn of a situation of interaction between users in the multimedia interaction room. A user corresponding to the third virtual object does not join the multimedia interaction room.

In an implementation of this embodiment, operation 549a in this embodiment may be implemented as at least one of the following operations.
When the background audio is played in the multimedia interaction room, display a first decoration around the virtual building.

For example, the first decoration includes at least one of a virtual bonfire, a virtual color flag, and a virtual note. The first decoration is displayed around the virtual building, to indicate, to another virtual object in the virtual scene, whether the background audio is played in the multimedia interaction room corresponding to the virtual building.
Display the virtual building with a periodic swing based on an audio melody of the background audio, where a swing frequency of the periodic swing is related to the audio melody of the background audio.

For example, when the virtual building performs the periodic swing, a display scale of the virtual building is changed, to display that the virtual building swings. The audio melody of the background audio is configured for indicating a beat of the background audio, and the swing frequency of the virtual building is the same as the beat of the background audio.
Display a second decoration on the virtual building based on audio information of the background audio.

For example, the second decoration includes at least one of an avatar of at least one of a lyricist, a composer, and a producer of the background audio, a cover of an album to which the background audio belongs, and an issuer identifier of the background audio.
When an activation frequency of the audio collection function exceeds an activation threshold, display a third decoration on the virtual building.

For example, when the activation frequency of the audio collection function exceeds the activation threshold, the first virtual object frequently transmits a voice message, and/or frequently uses the real-time voice function. The third decoration is displayed to indicate, to another virtual object in the virtual scene, that an interaction frequency in the multimedia interaction room corresponding to the virtual building is high. For example, the third decoration is a microphone.

In conclusion, in the method provided in this embodiment, the multimedia interaction room is displayed as the virtual building in the virtual scene, and the first user joins the multimedia interaction room when the entry condition of the virtual building is satisfied, so that a manner of joining the multimedia interaction room is expanded in the virtual scene. The multimedia interaction function provided by the multimedia interaction room is invoked through the first audio control operation and the second audio control operation, so that multimedia interaction between at least two users in the multimedia interaction room is implemented. The display manner of the virtual building is updated based on the background audio and the audio collection function, so that a connection between the display manner in the virtual scene and an interaction behavior of the user in the multimedia interaction room is established.

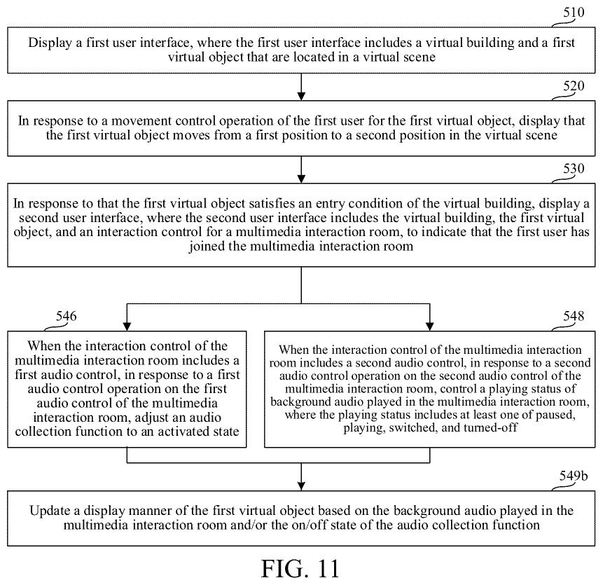

FIG. 11 is a flowchart of a method for implementing multimedia interaction according to some embodiments of this application. An example in which the method is performed by a terminal is used for description. To be specific, based on the embodiment shown in FIG. 9, operation 549b is further included.

Operation 549b: Update a display manner of the first virtual object based on the background audio played in the multimedia interaction room and/or the on/off state of the audio collection function.

For example, the display manner of the first virtual object is related to setting of the background audio and/or the audio collection function by the user of the multimedia interaction room. For example, for a third virtual object in the virtual scene, the third virtual object may observe the first virtual object around the virtual building to learn of a situation of the setting of the background audio and/or the on/off state of the audio collection function by the user in the multimedia interaction room, and learn of a situation of interaction between users in the multimedia interaction room. A user corresponding to the third virtual object does not join the multimedia interaction room.

In an implementation of this embodiment, operation 549b in this embodiment may be implemented as at least one of the following operations.
When the background audio is played in the multimedia interaction room, display the first virtual object around the virtual building.

When the background audio is played in the multimedia interaction room, the first virtual object is displayed around the virtual building. The first virtual object and the second virtual object form an interaction queue, and perform a virtual activity, to implement multimedia interaction between users. For example, when the background audio is played in the multimedia interaction room, multiuser microphone-connected chatting is performed between the users. The background audio provides an interaction melody for the multimedia interaction room. For example, cheerful background audio that helps perform high-frequency microphone-connected chatting between the users. The first virtual object is displayed around the virtual building when the multiuser microphone-connected chatting is performed between the users, so that another virtual objects in the virtual scene is attracted to join the multimedia interaction room, thereby providing immersive experience.
When the background audio stops being played in the multimedia interaction room, display that the first virtual object enters the virtual building.

When the background audio stops being played in the multimedia interaction room, that the first virtual object enters the virtual building is displayed, to indicate, to the another virtual object in the virtual scene, whether the background audio is played in the multimedia interaction room corresponding to the virtual building. For example, when the background audio stops being played in the multimedia interaction room, the multiuser microphone-connected chatting between the users is not performed, but private chatting between the users is performed, and the first virtual object is displayed to enter the virtual building. The another virtual object in the virtual scene learns that the private chatting between the users rather than the multiuser microphone-connected chatting is performed in the multimedia interaction room. The another virtual object in the virtual scene determines, based on a social need, whether to join the multimedia interaction room.
Display, based on an audio lyric of the background audio, that the first virtual object possesses a first item associated with the audio lyric.

For example, the audio lyric of the background audio may be obtained from a lyric file of the background audio, or may be obtained by performing voice recognition on the background audio. For example, the first item may be an item that is the same as the audio lyric, or may be an item belonging to a same category as that of the audio lyric. For example, when the audio lyric includes “a spring breeze blows, a tree turns green, and a swallow flies back,” the first virtual object possesses at least one of a virtual bird, a virtual branch, a virtual flower, and a virtual windmill. The virtual bird and the virtual branch are items actually appearing in the audio lyric, and the virtual flower and the virtual windmill are items associated with “spring breeze” in the audio lyric. For example, when the background audio is played in the multimedia interaction room, the multiuser microphone-connected chatting is performed between the users. The another virtual object in the virtual scene directly views information about the background audio of the multimedia interaction room in the virtual scene based on the first item possessed by the first virtual object, and learns of an atmosphere of the microphone-connected chatting in the multimedia interaction room based on the background audio, to determine whether to join the multimedia interaction room without viewing historical interaction information of the multimedia interaction room.
When the audio collection function is in the activated state, display a speaking identifier around the first virtual object.

For example, when the audio collection function is in the activated state, the speaking identifier is displayed around the first virtual object. The speaking identifier indicates, to another virtual object and a user corresponding to a second virtual object in the multimedia interaction room in the virtual scene, a virtual object that currently transmits a voice message and/or uses the real-time voice function. For example, the another virtual object in the virtual scene obtains speaking frequencies of different users in the multimedia interaction room based on the speaking identifier of the first virtual object, and determines whether to join the multimedia interaction room. The another virtual object does not need to get familiar with a speaking behavior habit of a member in the multimedia interaction room after entering the multimedia interaction room. In addition, a case in which the another virtual object joins the multimedia interaction room when long-time speaking is performed and a speaking tempo of a speaking user is disrupted is avoided.

In conclusion, in the method provided in this embodiment, the multimedia interaction room is displayed as the virtual building in the virtual scene, and the user corresponding to the first virtual object joins the multimedia interaction room when the entry condition of the virtual building is satisfied, so that a manner of joining the multimedia interaction room is expanded in the virtual scene. The multimedia interaction function provided by the multimedia interaction room is invoked through the first audio control operation and the second audio control operation, so that multimedia interaction between at least two users in the multimedia interaction room is implemented. The display manner of the first virtual object is updated based on the background audio and the audio collection function, so that a connection between the display manner in the virtual scene and an interaction behavior of the user in the multimedia interaction room is established.

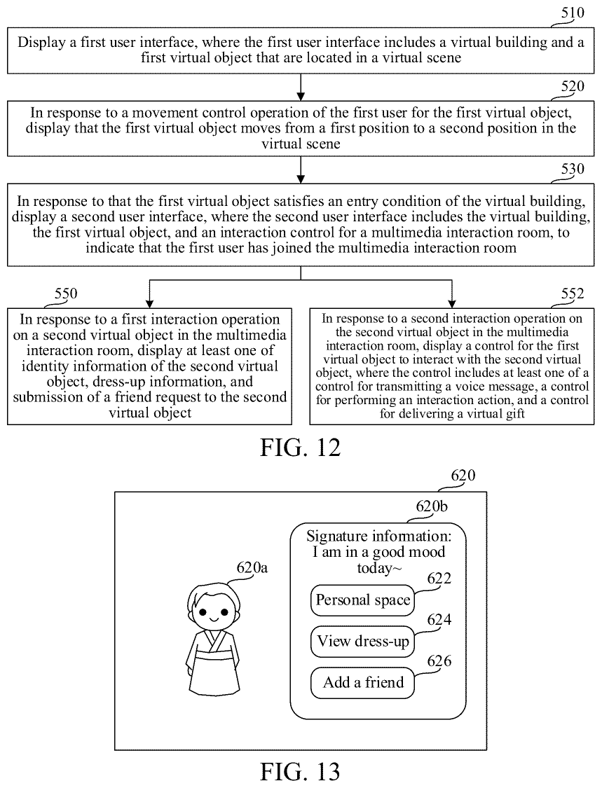

FIG. 12 is a flowchart of a method for implementing multimedia interaction according to some embodiments of this application. An example in which the method is performed by a terminal is used for description. To be specific, based on the embodiment shown in FIG. 3, operation 550 and operation 552 are further included.

Operation 550: In response to a first interaction operation on a second virtual object in the multimedia interaction room, display at least one of identity information of the second virtual object, dress-up information, and submission of a friend request to the second virtual object.

For example, the first interaction operation is an interaction operation for the second virtual object. In the first interaction operation, interaction information is not directly transmitted to the second virtual object. At least one of the identity information of the second virtual object, the dress-up information, and submitting the friend request to the second virtual object is displayed on a same interface or different interfaces. Related information of the second virtual object is viewed through the first interaction operation on the second virtual object.

FIG. 13 is a schematic diagram showing an identity information interface according to some embodiments of this application.

A second virtual object 620a and a data card 620b are displayed on an identity information interface 620. The data card 620b includes basic identity information of the first virtual object, such as signature information. The data card 620b further includes a personal space control 622, a dress-up viewing control 624, and a friend adding control 626, respectively a function entrance to identity information of the second virtual object, a function entrance to viewing dress-up information of the second virtual object, and a function entrance to submitting a friend request to the second virtual object.

This embodiment shows only an implementation in which the data card 620b displays the basic identity information and provides the function entrance. In another implementation, all the identity information, or only the function entrance is provided on the identity information interface. This embodiment does not constitute a limitation on the identity information interface, and all interfaces presenting the identity information of the second virtual object may be referred to as the identity information interface.

Operation 552: In response to a second interaction operation on the second virtual object in the multimedia interaction room, display a control for the first virtual object to interact with the second virtual object, where the control includes at least one of a control for transmitting a voice message, a control for performing an interaction action, and a control for delivering a virtual gift.

For example, the second interaction operation is an interaction operation for the second virtual object, and the second interaction operation is configured for directly transmitting the interaction information to the second virtual object, for example, at least one of transmitting a voice message to the second virtual object, performing an interaction action with the second virtual object, and delivering a virtual gift to the second virtual object by the first virtual object.

For example, the voice message transmitted by the first virtual object may be a specific message transmitted to the second virtual object, or may be a broadcast message transmitted to all members in the multimedia interaction room.

In conclusion, in the method provided in this embodiment, the multimedia interaction room is displayed as the virtual building in the virtual scene, and the user corresponding to the first virtual object joins the multimedia interaction room when the entry condition of the virtual building is satisfied, so that a manner of joining the multimedia interaction room is expanded in the virtual scene. The first virtual object directly or indirectly interacts, through the first interaction operation and the second interaction operation, with an account corresponding to the second virtual object in the multimedia interaction room, so that multimedia interaction between at least two users in the multimedia interaction room is implemented.

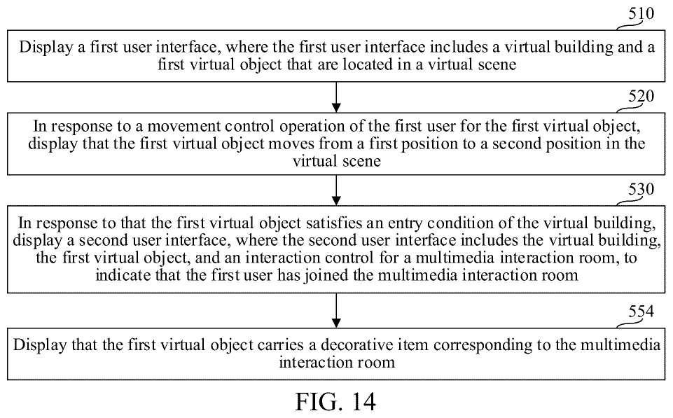

FIG. 14 is a flowchart of a method for implementing multimedia interaction according to some embodiments of this application. An example in which the method is performed by a terminal is used for description. To be specific, based on the embodiment shown in FIG. 3, operation 554 is further included.

Operation 554: Display that the first virtual object wears a decorative item corresponding to the multimedia interaction room.

For example, after the first user corresponding to the first virtual object joins the multimedia interaction room, the first virtual object wears the decorative item corresponding to the multimedia interaction room. At least one of a color, a material, a pattern, and a texture of the decorative item corresponding to the multimedia interaction room is the same as that of the virtual building.

For example, the decorative item includes, but is not limited to, at least one of items such as clothes, jewelry, a hat, shoes, a backpack, a badge, a special-effect animation, and a vehicle.

In an implementation of this embodiment, the multimedia interaction room corresponds to an interaction label, and the interaction label corresponds to an interaction platform. Operation 554 in this embodiment may be implemented as the following operations.

The first virtual object wearing an associated decorative item corresponding to the interaction label is displayed.

For example, the interaction label may be directly obtained based on title information of the multimedia interaction room, or may be determined based on an interaction behavior between members in the multimedia interaction room. The associated decorative item is determined based on decoration information of a second account belonging to the interaction platform and/or platform behavior information, and the second account has a binding relationship with the first virtual object.

For example, the interaction label is a first game, and the first game corresponds to a first game platform. A virtual character usually used by the second account in the first game platform is a first soldier, and a skin used is a skin dedicated to Labor Day. The first virtual object wearing first clothes is displayed, where a first display character of the skin dedicated to Labor Day is drawn on the first clothes.

For example, the interaction label is music, and the music corresponds to a first audio platform. Song preference of the second account in the first audio platform is at least one of cheerful, romantic, lyrics, and sad. When the song preference is cheerful, a color of the decorative item is orange. When the song preference is romantic, the color of the decorative item is red. When the song preference is lyrics, the color of the decorative item is green. When the song preference is sad, the color of the decorative item is blue. The song preference of the second account in the first audio platform is determined based on platform behavior information. Specifically, the platform behavior information is historical audio-playing information.

In an implementation of this embodiment, this embodiment further includes the following operation.

The interaction label is determined based on at least one of room name information, room introduction information, and interaction information that are of the multimedia interaction room.

For example, the interaction label may be directly from related information of the multimedia interaction room. For example, the room name information indicates an interaction theme of the multimedia interaction room, and the room introduction information is configured for introducing interaction in the multimedia interaction room. For example, the interaction label may be obtained through prediction based on the interaction information of the multimedia interaction room. The interaction label is obtained through prediction based on the interaction behavior between members in the multimedia interaction room.

In conclusion, in the method provided in this embodiment, the multimedia interaction room is displayed as the virtual building in the virtual scene, and the user corresponding to the first virtual object joins the multimedia interaction room when the entry condition of the virtual building is satisfied, so that a manner of joining the multimedia interaction room is expanded in the virtual scene. Joining the multimedia interaction room is transformed into an activity behavior of the virtual object in the virtual scene, so that interaction of the virtual object in the virtual scene is promoted, and immersive experience in the virtual scene is improved. The first virtual object wearing the decorative item corresponding to the multimedia interaction room is displayed, so that a connection between the virtual scene and the multimedia interaction room is established, the interaction label of the multimedia interaction room is fully utilized, it is ensured that a first virtual object displaying the decorative item related to the interaction label in the virtual scene, and a change of clothes of the first virtual object is avoided, thereby improving human-computer interaction efficiency.

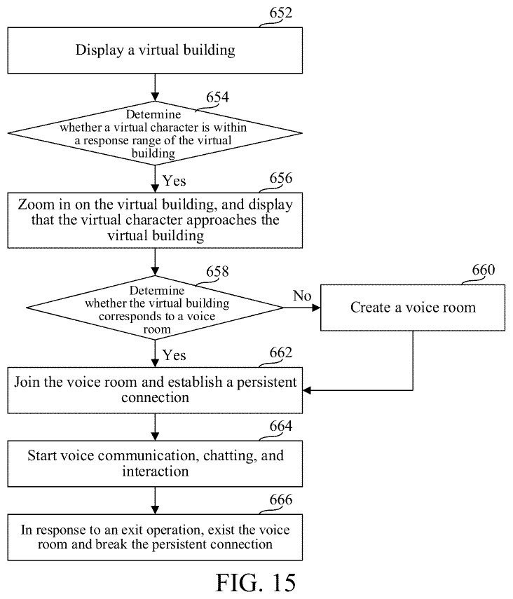

FIG. 15 is a flowchart of a method for implementing multimedia interaction according to some embodiments of this application. An example in which the method is performed by a terminal is used for description. The method includes the following operations.

Operation 652: Display a virtual building.

For example, the virtual building in a virtual scene corresponds to a multimedia interaction room. The multimedia interaction room may be specifically implemented as a voice room.

For example, the virtual building is displayed in the virtual scene. The virtual scene is also referred to as a state plaza and is multiuser real-time online logic. A virtual character walks in the state plaza, and may tap the virtual building within an effective distance to enter the voice room, and performs multiuser voice chatting in real time. After the virtual character enters the voice room, the virtual character invokes a microphone to perform real-time voice communication. An upper limit of a quantity of people in the voice room may be dynamically adjusted, and after the quantity of people reaches the upper limit, no people is supported to join the voice room. Configuring and playing of background music is supported in space. From a third perspective, a plurality of virtual characters gather together to perform social interaction.

For example, after a user corresponding to the virtual character registers and logs in, the virtual character is in an online state when entering the state plaza. When the user corresponding to the virtual character logs out or exits an application program, the virtual character is in an offline state and leaves the state plaza.

Operation 654: Determine whether the virtual character is within a response range of the virtual building.

For example, the virtual building corresponds to the response range, and the response range is centered on the virtual building.

Operation 656: When the virtual character is within the response range of the virtual building, zoom in on the virtual building, and display that the virtual character approaches the virtual building.

For example, when the virtual character is within the response range of the virtual building, the virtual building is zoomed in and displayed, and the virtual building zoomed in and displayed is in a selected state. The virtual character is also referred to as a first virtual object.

Operation 658: Determine whether the virtual building corresponds to a voice room.

For example, whether the virtual building corresponds to the voice room is determined. When a user exists in the voice room, the virtual building corresponds to the voice room.

Operation 660: When it is determined that the virtual building does not correspond to a voice room, create a voice room.

For example, a user in the voice room corresponds to a virtual character.

Operation 662: When it is determined that the virtual building corresponds to a voice room, join the voice room and establish a persistent connection.

For example, the virtual building corresponds to the voice room, and a user corresponding to the virtual character joins the voice room. A persistent connection between a user terminal corresponding to the virtual character and the voice room (an audio and video server) is established. The voice room is configured for providing a multimedia interaction function for at least two users. For example, the terminal requests to enter the virtual building from a service server. After receiving the request, the service server updates service data, and requests the audio and video server for information about the voice room corresponding to the virtual building.

The service server returns both related information of the virtual building and the obtained information about the voice room to the terminal. The terminal transfers information data of the voice room to an accessed audio and video software development kit (SDK). The audio and video SDK implements capabilities such as establishing a persistent connection with the audio and video server, encoding and decoding, and pushing and pulling a stream, and finally implements a capability of communication, chatting, and interaction through audio and video of a service.

Operation 664: Start voice communication, chatting, and interaction.

For example, members in the voice room perform communication, chatting, and interaction through voice.

Operation 666: In response to an exit operation, exist the voice room and disconnect the persistent connection.

For example, in response to the exit operation, the user corresponding to the virtual character exists the voice room. The persistent connection between the user terminal corresponding to the virtual character and the voice room (the audio and video server) is broken.

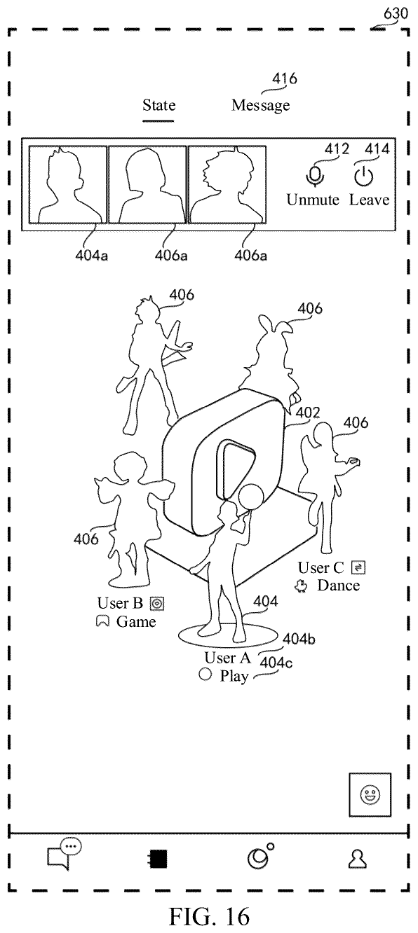

FIG. 16 is a schematic diagram showing a virtual scene according to some embodiments of this application.

A first virtual object 404 and a second virtual object 406 surrounding a virtual building 402 to form an interaction queue is displayed on a fourth interface 630. A quantity of second virtual objects 406 is four, and the first virtual object 404 and the second virtual object 406 surround the virtual building 402 to form a circular interaction queue. The Virtual building 402 is implemented as a virtual sculpture. An identity nickname 404b and state information 404c of the first virtual object 404 are further displayed on the fourth interface 630. The identity nickname 404b of the first virtual object 404 is “user A.” The state information 404c of the first virtual object 404 is a playing state. For example, for case of representation, only portrait outlines of the first virtual object 404 and the second virtual object 406 are shown.

A first avatar 404a of the first virtual object 404 and a second avatar 406a of the second virtual object 406 are displayed on the fourth interface 630. Limited by a display size of a page, only avatar information of a part of the second virtual objects 406 is displayed. A microphone control 412 on the fourth interface is configured for providing an adjustment entrance to an audio collection function, an exit control 414 is configured for providing a function entrance for exiting a multimedia interaction room, and an interface switching control 416 is configured for providing a function entrance for switching to display a message list interface. For the displaying of the message list interface and the audio collection function, refer to the foregoing descriptions.

A person of ordinary skill in the art may understand that, the foregoing embodiments may be independently implemented, or may be combined in different manners to form a new embodiment, to implement the method for implementing multimedia interaction of this application.

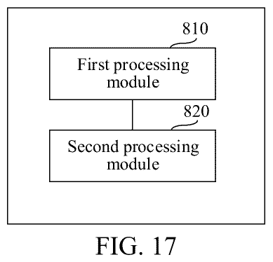

FIG. 17 is a block diagram of an apparatus for implementing multimedia interaction according to some embodiments of this application. The apparatus includes:
a first processing module 810, configured to display a first user interface, where the first user interface includes a virtual building and a first virtual object that are located in a virtual scene, the virtual building represents an entrance to a multimedia interaction room, the multimedia interaction room is a virtual room providing a multimedia interaction function, and the first virtual object is controlled by a first user; and in response to a movement control operation of the first user for the first virtual object, display that the first virtual object moves from a first position to a second position in the virtual scene; and
a second processing module 820, configured to: in response to that the first virtual object satisfies an entry condition of the virtual building, display a second user interface, where the second user interface includes the virtual building, the first virtual object, and an interaction control for the multimedia interaction room, to indicate that the first user has joined the multimedia interaction room.

The entry condition at least includes the second position being within an effective response range of the virtual building.

When the apparatus provided in the foregoing embodiment implements functions of the apparatus, the division of the foregoing functional modules is merely used as an example for description. During actual application, the foregoing functions may be assigned to be completed by different functional modules based on actual needs, that is, an internal structure of the device is divided into different functional modules to implement all or some of the functions described above.

For the apparatus in the foregoing embodiment, specific manners of executing operations by the modules are described in detail in embodiments related to the method. Technical effects achieved by the modules executing the operations are the same as those in the embodiments related to the method, and details are not described herein again.

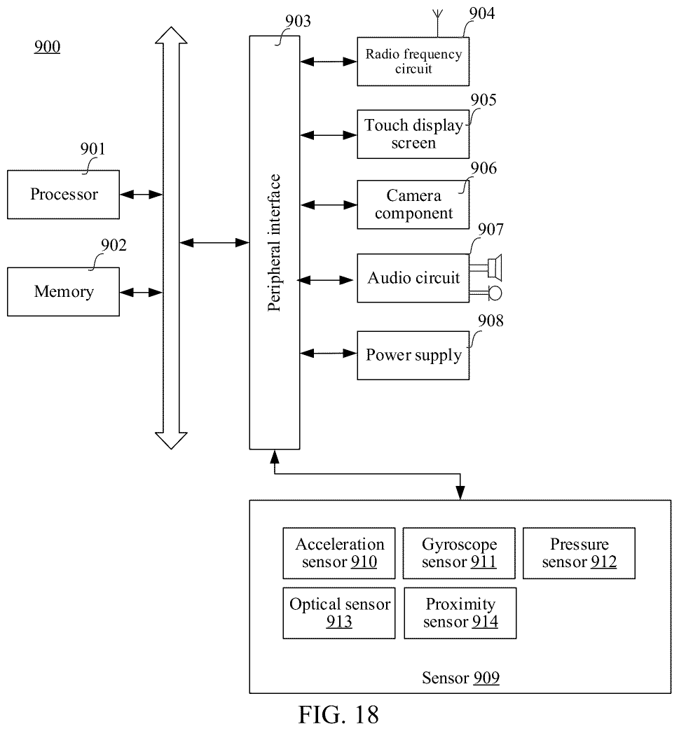

FIG. 18 is a block diagram showing a structure of a computer device 900 according to some embodiments of this application. The computer device 900 may be a portable mobile terminal, such as a smartphone, a tablet computer, an MP3 player, or an MP4 player. The computer device 900 may also be referred to as another name such as user equipment or a portable terminal.

Generally, the computer device 900 includes a processor 901 and a memory 902.

The processor 901 may include one or more processing cores, such as a 4-core processor or an 8-core processor. The processor 901 may be implemented by using at least one hardware form of a digital signal processor (DSP), a field programmable gate array (FPGA), and a programmable logic array (PLA). The processor 901 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 901 may be integrated with a graphics processing unit (GPU). The GPU is configured to render and draw content that needs to be displayed in a display. In some embodiments, the processor 901 may further include an artificial intelligence (AI) processor. The AI processor is configured to process a computing operation related to machine learning.

The memory 902 may include one or more computer-readable storage media. The computer-readable storage medium may be tangible and non-transitory. The memory 902 may further include a high-speed random access memory and a non-volatile memory, such as one or more disk storage devices or flash memory devices. In some embodiments, the non-transitory computer-readable storage medium in the memory 902 is configured to store at least one instruction, and the at least one instruction is configured to be executed by the processor 901 to implement the method for implementing multimedia interaction provided in the embodiments of this application.

In some embodiments, the computer device 900 may further include: a peripheral interface 903 and at least one peripheral. Specifically, the peripheral includes: at least one of a radio frequency circuit 904, a touch display screen 905, a camera 906, an audio circuit 907, and a power supply 908.

The peripheral interface 903 may be configured to connect at least one peripheral related to I/O to the processor 901 and the memory 902. In some embodiments, the processor 901, the memory 902, and the peripheral interface 903 are integrated on a same chip or circuit board. In some other embodiments, any one or two of the processor 901, the memory 902, and the peripheral interface 903 may be implemented on a single chip or circuit board. This is not limited in this embodiment.

The radio frequency circuit 904 is configured to receive and transmit a radio frequency (RF) signal, also referred to as an electromagnetic signal. The radio frequency circuit 904 communicates with a communication network and another communication device through the electromagnetic signal.

The touch display screen 905 is configured to display a user interface (UI). The UI may include a graph, a text, an icon, a video, and any combination thereof.

The camera component 906 is configured to collect an image or a video.

The audio circuit 907 is configured to provide an audio interface between a user and the computer device 900.

The power supply 908 is configured to supply power to components in the computer device 900.

In some embodiments, the computer device 900 further includes one or more sensors 909. The one or more sensors 909 include, but are not limited to: an acceleration sensor 910, a gyroscope sensor 911, a pressure sensor 912, an optical sensor 913, and a proximity sensor 914.

A person skilled in the art may understand that the structure shown above does not constitute any limitation on the computer device 900, and the computer device 900 may include more components or fewer components than those shown in the figure, or some components may be combined, or a different component deployment may be used.

In an exemplary embodiment, a chip is further provided. The chip includes a programmable logic circuit and/or program instructions, and when running on the computer device, the chip is configured to implement the method for implementing multimedia interaction in the foregoing aspect.

In an exemplary embodiment, a computer program product is further provided. The computer program product includes computer instructions, and the computer instructions are stored in a computer-readable storage medium. A processor of a computer device reads the computer instructions from the computer-readable storage medium, and executes the computer instructions, to implement the method for implementing multimedia interaction provided in the foregoing method embodiments.

In an exemplary embodiment, a computer-readable storage medium is further provided. The computer-readable storage medium has a computer program stored therein, and the computer program is loaded and executed by a processor to implement the method for implementing multimedia interaction provided in the foregoing method embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

A person skilled in the art should be aware that in the one or more examples, the functions described in the embodiments of this application may be implemented by using hardware, software, firmware, or any combination thereof. When implemented by using software, the functions may be stored in a computer-readable medium or may be used as one or more instructions or code in the computer-readable medium for transferring. The computer-readable medium includes a computer storage medium and a communication medium. The communication medium includes any medium that enables a computer program to be transmitted from one place to another. The storage medium may be any available medium accessible to a general-purpose or dedicated computer.

The foregoing descriptions are merely optional embodiments of this application, but are not intended to limit this application. Any modification, equivalent replacement, or improvement made within the spirit and principle of this application shall fall within the protection scope of this application.

What is claimed is:

1. A method for implementing multimedia interaction, performed by a terminal, comprising:
displaying a first user interface, the first user interface including a virtual building and a virtual object that are located in a virtual scene, the virtual building representing an entrance to a multimedia interaction room;
in response to a movement control operation on the virtual object, displaying that the virtual object moves from a first position to a second position in the virtual scene; and
in response to that the virtual object satisfies an entry condition of the virtual building, displaying a second user interface, the second user interface including the virtual building, the virtual object, and an interaction control;
wherein the entry condition at least includes the second position being within an effective response range of the virtual building.

2. The method according to claim 1,
wherein in response to the movement control operation, displaying that the virtual object moves from the first position to the second position includes:
in response to a trigger operation on a movement control, displaying that the virtual object moves from the first position to the second position indicated by the trigger operation;
the method further comprising:
in response to that the virtual object is located at the second position, displaying that a display status of the virtual building is switched from an unselected state to a selected state.

3. The method according to claim 2, further comprising:
receiving a tap operation on the virtual building in the selected state; and
in response to the tap operation, determining that the virtual object satisfies the entry condition of the virtual building.

4. The method according to claim 1,
wherein the virtual object is a first virtual object;
the method further comprising:
displaying one or more second virtual objects around the virtual building on the first user interface, the one or more second virtual objects being distributed around the virtual building and forming an interaction queue around the virtual building; and
in response to that the first virtual object satisfies the entry condition of the virtual building, displaying, on the first user interface, that the first virtual object moves to a position close to the interaction queue and joins the interaction queue.

5. The method according to claim 4, wherein:
the one or more second virtual objects include a target second virtual object, and the target second virtual object has management permission of the multimedia interaction room; and
displaying that the first virtual object moves to the position close to the interaction queue and joins the interaction queue includes:
displaying that the first virtual object moves to a position close to the target second virtual object in the interaction queue, and displaying that the first virtual object performs a first interaction action on the target second virtual object; and
in response to that the target second virtual object performs a second interaction action responding to the first virtual object, displaying that the first virtual object joins the interaction queue.

6. The method according to claim 4, further comprising:
in response to an interaction operation on one second virtual object of the one or more second virtual objects on the second user interface, displaying at least one of identity information of the second virtual object, dress-up information, and submission of a friend request to the one second virtual object; and

7. The method according to claim 4, further comprising:
in response to an interaction operation on one second virtual object of the one or more second virtual objects on the second user interface, displaying a control for the first virtual object to interact with the one second virtual object, the control including at least one of a control for transmitting a voice message, a control for performing an interaction action, and a control for delivering a virtual gift.

8. The method according to claim 1, wherein:
the virtual building is displayed at a first size on the first user interface and at a second size on the second user interface, the second size being greater than the first size.

9. The method according to claim 1,
wherein the virtual building is displayed in a first display style on the first user interface;
the method further comprising:
in response to determining that a user corresponding to the virtual object has capacity expansion permission of the multimedia interaction room, displaying the virtual building in a second display style on the second user interface, to indicate that a maximum quantity of members allowed to be carried by the multimedia interaction room increases, the first display style being different from the second display style.

10. The method according to claim 9, further comprising:
displaying information about the virtual object above the virtual building in the second display style.

11. The method according to claim 1,
wherein the virtual building is displayed in a first display style on the first user interface;
the method further comprising:
in response to determining that a user corresponding to the virtual object has an identity identifier and a quantity of users with a specific identity identifier in the multimedia interaction room increases and exceeds a preset quantity threshold, displaying the virtual building in a second display style on the second user interface, to indicate that the quantity of users with the specific identity identifier in the multimedia interaction room exceeds the preset quantity threshold, the first display style being different from the second display style.

12. The method according to claim 1, further comprising:
in response to an interface switching operation on the first user interface or the second user interface, displaying a message list interface, the message list interface including a message indicating the virtual object has joined the multimedia interaction room.

13. The method according to claim 1,
wherein the interaction control includes a first audio control and a second audio control;
the method further comprising:
in response to a first audio control operation on the first audio control, adjusting an audio collection function to an activated state; and
in response to a second audio control operation on the second audio control, controlling a playing status of background audio played in the multimedia interaction room, the playing status includes at least one of paused state, playing state, switched state, and turned-off state.

14. The method according to claim 13, further comprising:
updating a display manner of the virtual building based on the background audio played in the multimedia interaction room and/or an on/off state of the audio collection function.

15. The method according to claim 13, further comprising:
updating a display manner of the virtual object based on the background audio played in the multimedia interaction room and/or an on/off state of the audio collection function.

16. The method according to claim 1, wherein the virtual object displayed on the second user interface wears a decorative item corresponding to the multimedia interaction room.

17. The method according to claim 16, wherein:
an interaction label is set for the multimedia interaction room, the interaction label is determined based on at least one of room name information, room introduction information, and room interaction information of the multimedia interaction room, and the interaction label corresponds to an interaction platform; and
the decorative item worn by the virtual object includes an associated decorative item corresponding to the interaction label, the associated decorative item being determined based on decoration information of an account belonging to the interaction platform and/or platform behavior information, and the account has a binding relationship with the virtual object.

18. A computer device comprising:
at least one processor; and
at least one memory storing at least one program that, when executed by the at least one processor, causes the computer device to:
display a first user interface, the first user interface including a virtual building and a virtual object that are located in a virtual scene, the virtual building representing an entrance to a multimedia interaction room;
in response to a movement control operation on the virtual object, display that the virtual object moves from a first position to a second position in the virtual scene; and
in response to that the virtual object satisfies an entry condition of the virtual building, display a second user interface, the second user interface including the virtual building, the virtual object, and an interaction control;
wherein the entry condition at least includes the second position being within an effective response range of the virtual building.

19. The computer device according to claim 18, wherein the at least one program, when executed by the at least one processor, further causes the computer device to:
when in response to the movement control operation, displaying that the virtual object moves from the first position to the second position:
in response to a trigger operation on a movement control, display that the virtual object moves from the first position to the second position indicated by the trigger operation; and
in response to that the virtual object is located at the second position, display that a display status of the virtual building is switched from an unselected state to a selected state.

20. A non-transitory computer-readable storage medium storing one or more executable instructions that, when loaded and executed by at least one processor of a computer device, cause the computer device to:
display a first user interface, the first user interface including a virtual building and a virtual object that are located in a virtual scene, the virtual building representing an entrance to a multimedia interaction room;
in response to a movement control operation on the virtual object, display that the virtual object moves from a first position to a second position in the virtual scene; and
in response to that the virtual object satisfies an entry condition of the virtual building, display a second user interface, the second user interface including the virtual building, the virtual object, and an interaction control;
wherein the entry condition at least includes the second position being within an effective response range of the virtual building.
